(19) United States
(12) Patent Application Publication
(10) Pub. No.: US 2024/0010840 A1
(43) Pub. Date: Jan. 11, 2024

(54) METHOD FOR PRODUCING CROSS-LINKABLE MATERIALS BASED ON ORGANYLOXYSILANE-TERMINATED POLYMERS

(71) Applicant: Wacker Chemie AG, Munich (DE)

(72) Inventors: Volker STANJEK, Ampfing (DE); Lars ZANDER, Altötting (DE)

(73) Assignee: Wacker Chemie AG, Munich (DE)

(21) Appl. No.: 18/038,449

(22) PCT Filed: Dec. 15, 2020
(86) PCT No.: PCT/EP2020/086176

§ 371 Date: May 24, 2023

(51) Int. Cl. C08L 101/10; C09J 201/10; C09K 3/10

(52) U.S. Cl. CPC C08L 101/10; C09J 201/10; C09K 3/10

(57) ABSTRACT

A method for producing crosslinkable compositions (M) by mixing (A) 100 parts by weight of compounds of the formula Y—[(CR¹₂)_{b}—SiRₐ(OR²)₃₋ₐ]ₓ (I) and (B) 0.1 to 75 parts by weight of at least one thixotropic agent. The at least one thixotropic agent is selected from fatty acid amides, polyamide waxes, polyamide wax derivatives, hydrogenated castor oil, hydrogenated castor oil derivatives, polyester amides, polyureas, oxidized polyethylenes and metal soaps and optionally further components. The period of time from the start of the mixing step of (A) and (B) to the end of storage of the crosslinkable composition (M) is at least 7 days and during this period all process steps are carried out at temperatures below 59° C.

The invention relates to a method for producing crosslinkable compositions based on organyloxysilane-terminated polymers, preferably one-component, crosslinkable compositions, and use thereof as adhesives and sealants, in particular as low-modulus sealants.

Polymer systems which have reactive alkoxysilyl groups have been known for a long time. On contact with water or atmospheric moisture, these alkoxysilane-terminated polymers are able to condense with one another even at room temperature, with elimination of the alkoxy groups. One of the most important applications of such materials is the manufacture of adhesives and sealants.

For instance, adhesives and sealants based on alkoxysilane-crosslinking polymers not only exhibit good adhesion properties on some substrates in the cured state, but also very good mechanical properties, since they can exhibit both sufficient breaking strength and high elasticity for many applications. A further advantage of silane-crosslinking systems compared to numerous other adhesive and sealant technologies (for example compared to isocyanate-crosslinking systems) is the toxicological safety of the prepolymers.

In many applications, single-component systems (1 K systems) that cure on contact with atmospheric moisture are preferred. The decisive advantages of one-component systems are especially the very ready applicability thereof, since no mixing of different adhesive components by the user is required here. In addition to the time/work savings and the reliable avoidance of possible dosage errors, one-component systems also do not require the adhesive/sealant to be processed within a usually quite narrow time window, as is the case with multi-component systems after mixing the two components.

There are now numerous variants of adhesive and sealant systems based on silane-crosslinking prepolymers.

A first particular variant consists of the use of so-called α-silane-terminated prepolymers. These have reactive alkoxysilyl groups linked to an adjacent urethane unit by a methylene spacer. This compound class is highly reactive and requires neither tin catalysts nor strong acids or bases to achieve high curing rates in contact with air. Commercially available α-silane terminated prepolymers are GENIOSIL® STP-E10 or -E30 from Wacker Chemie AG.

A second particular variant, which is of particular interest for adhesives based on silane-crosslinking polymers, is described, for example, in EP 2 744 842 A, which also contains phenylsilicone resins in addition to the silane-crosslinking polymers. The appropriate resin additives also result in adhesives that exhibit significantly improved hardness and tensile shear strength once fully cured.

A third particular variant, which is of particular interest for sealants based on silane-crosslinking polymers, is described for example in EP 3 149 095 A. Therein, the customary, preferably linear silane-crosslinking polymers comprising a crosslinkable silane function at both chain ends of their chain ends are mixed with silane-crosslinking polymers having reactive silane groups at only one chain end.

For many applications, both in the area of adhesives and sealants, formulations having a high thixotropy are desired, i.e. formulations that have a low viscosity at high shear rates and can therefore be applied from the cartridge or other container with little or at least moderate force, while at low shear rates in contrast, they are highly viscous, ideally stable, so that the applied adhesive or sealant remains in place after application thereof until it has cured. This property is indispensable, especially for sealants that may also be used to seal vertical joints.

The desired thixotropy is usually achieved by adding a thixotropic agent, polyamide waxes or derivatives thereof being particularly suitable. Such thixotropic agents and use thereof in formulations based on silane-crosslinking polymers have been described many times, inter alia in EP 1 767 584 A.

However, a disadvantage of the use of such thixotropic agents is the fact that they generally have to be activated by thermal treatment of the formulation, which results in at least partial melting of the thixotropic agent. This thermal treatment can be carried out either during or directly after mixing of the formulation constituents or, as described for example in EP 1 767 584 A, only after the finished formulation has been filled into cartridges or other application containers.

However, regardless of the procedure chosen, the requirement for thermal treatment represents an additional process step. If this is carried out during or directly after the mixing step, which is usually carried out in large-volume mixers, this leads to a considerable extension in the plant occupancy time and thus to considerably higher production costs. If, on the other hand, the thermal treatment is only carried out by heating the respective final container, this involves considerable additional logistical effort and also requires additional heating chambers and/or other technical equipment, which in many cases are not available.

The object of the invention was therefore the development of a method which no longer has the disadvantages of the prior art.

The invention relates to a method for producing crosslinkable compositions (M) by mixing
(A) 100 parts by weight of compounds of the formula

Y—[(CR¹₂)_{b}—SiRₐ(OR²)₃₋ₐ]ₓ (I),
where
Y is an x-valent polymer radical bonded via nitrogen, oxygen, sulfur or carbon,
R may be the same or different and is a monovalent, optionally substituted hydrocarbon radical,
R¹ may be the same or different and is a hydrogen atom or a monovalent, optionally substituted hydrocarbon radical which can be attached to the carbon atom via nitrogen, phosphorus, oxygen, sulfur or a carbonyl group,
R² may be the same or different and is a hydrogen atom or a monovalent, optionally substituted hydrocarbon radical,
x is an integer from 1 to 10, preferably 1, 2 or 3, particularly preferably 1 or 2,
a may be the same or different and is 0, 1 or 2, preferably 0 or 1, and
b may be the same or different and is an integer from 1 to 10, preferably 1, 3 or 4, particularly preferably 1 or 3, especially 1, and
(B) 0.1 to 75 parts by weight of at least one thixotropic agent selected from fatty acid amides, polyamide waxes, polyamide wax derivatives, hydrogenated castor oil, hydrogenated castor oil derivatives, polyester amides, polyureas, oxidized polyethylenes and metal soaps,
and optionally further components,
optionally further subsequent process steps and subsequent storage of the resulting mixture (M),
characterized in that the period of time from the start of the mixing step of (A) and (B) to the end of storage of the crosslinkable composition (M) is at least 7 days and during this period all process steps are carried out at temperatures below 80° C.

The start of the mixing step of (A) and (B) is defined here as the point in time at which partial or total amounts of (A) and (B) are combined for the first time. During this present and/or mixed in at the same time.

The end of storage of the crosslinkable composition (M) is defined as the point in time when the composition (M) is removed from a container (GB) for the purpose of crosslinking.

Examples of containers (GB) are cartridges, tubes, buckets, hoses or also large containers such as canisters or drums, wherein containers (GB) are preferably cartridges.

Further process steps after the mixing of (A) and (B) according to the invention and optionally further components may include any further processing steps of the mixture, such as thermal treatment, degassing or also further mixing steps following the thermal treatment and/or degassing.

Storage according to the invention in the method according to the invention preferably also includes filling and decanting the crosslinkable compositions (M) into containers (GB), wherein the filling can be carried out directly after mixing the individual constituents according to the invention or at any later time point during storage. Transfer steps from one container (GB) for interim storage into other containers (GB) can also be carried out during storage. The last container (GB) is used for the final application, e.g. as an adhesive, sealant or coating material.

Preferably, all process steps of the process according to the invention are carried out at temperatures below 69° C., particularly preferably below 59° C., especially below 49° C., starting with the mixing of components (A) and (B), the further process steps optionally carried out, and the storage, wherein during the storage according to the invention the finished compositions (M) can be filled, packaged and transported until use thereof as intended.

In the method according to the invention, mixing may be carried out in any manner known per se, such as by methods commonly used for the preparation of moisture-curing compositions. The sequence in which the various constituents are mixed with one another can be varied as desired.

The method according to the invention can be carried out at the pressure of the surrounding atmosphere, i.e. about 900 to 1100 hPa. Furthermore, it is possible to temporarily or permanently reduce the pressure, for example to 30 to 500 hPa absolute pressure, in order to remove volatile compounds and/or air.

Preferably, in the mixing of components (A) and (B) and optionally further components according to the invention, the mixture is stirred for at most 3 hours, particularly preferably for at most 2 hours, especially for at most 1 hour, optionally with heating by means of a heating device at temperatures below 80° C., preferably below 69° C., particularly preferably below 59° C., especially below 49° C.

In a particularly preferred embodiment, the mixing of components (A) and (B) and optionally further components according to the invention, is heated only by the frictional heat unavoidably released during the mixing process and at no time by a heating device.

In the method according to the invention, the period of time from the mixing together of components (A) and (B) and optionally further components and up to the end of storage of the crosslinkable composition (M) is preferably at least 10 days, particularly preferably at least 15 days, especially at least 20 days. Storage can be in any form, i.e. also in the final packaging for the end application. Preferably, storage is at least partially in the final packaging for the end application.

Storage according to the invention is preferably carried out at a temperature of −20 to 45° C., especially 0 to 35° C.

The method according to the invention is preferably carried out with exclusion of (atmospheric) moisture.

The invention is based on the surprising discovery that the thermal treatment for activating the thixotropic agent can be replaced by the long storage according to the invention. This saves the time and energy-consuming process step of a separate thermal treatment. Since the material according to the invention can obviously also be packaged, transported and delivered to intermediaries, and even to the end user, during the long storage according to the invention, as long as it is not used, the method according to the invention with the long storage periods according to the invention is often much more favorable for the producer of an adhesive or sealant than the conventional process, which provides for thermal activation of the thixotropic agent.

Examples of radicals R are alkyl radicals such as the methyl, ethyl, n-propyl, isopropyl, 1-n-butyl, 2-n-butyl, isobutyl, tert-butyl, n-pentyl, isopentyl, neopentyl, tert-pentyl radical; hexyl radicals such as the n-hexyl radical; heptyl radicals such as the n-heptyl radical; octyl radicals such as the n-octyl radical, isooctyl radicals and the 2,2,4-trimethylpentyl radical; nonyl radicals such as the n-nonyl radical; decyl radicals such as the n-decyl radical; dodecyl radicals such as the n-dodecyl radical; octadecyl radicals such as the n-octadecyl radical; cycloalkyl radicals such as the cyclopentyl, cyclohexyl, cycloheptyl radical and methylcyclohexyl radicals; alkenyl radicals such as the vinyl, 1-propenyl and the 2-propenyl radical; aryl radicals such as the phenyl, naphthyl, anthryl and phenanthryl radical; alkaryl radicals such as o-, m-, p-tolyl radicals; xylyl radicals and ethylphenyl radicals; and aralkyl radicals such as the benzyl radical, the α- and β-phenylethyl radical.

Examples of substituted radicals R include haloalkyl radicals, such as the 3,3,3-trifluoro-n-propyl radical, the 2,2,2,2′,2′,2′-hexafluoroisopropyl radical and the heptafluoroisopropyl radical, and haloaryl radicals, such as the o-, m- and p-chlorophenyl radical.

Preferably, radical R is a monovalent hydrocarbon radical having 1 to 6 carbon atoms optionally substituted by halogen atoms, particularly preferably alkyl radicals having 1 or 2 carbon atoms, especially the methyl radical.

Examples of radicals R¹ are hydrogen atom, the radicals specified for R and optionally substituted hydrocarbon radicals bonded to the carbon atom via nitrogen, phosphorus, oxygen, sulfur, carbon or a carbonyl group.

The radical R¹ is preferably a hydrogen atom or hydrocarbon radicals having 1 to 20 carbon atoms, in particular a hydrogen atom.

Examples of radical R² are hydrogen atom and the examples given for radical R.

The radical R² is preferably a hydrogen atom or alkyl radicals having 1 to 10 carbon atoms, particularly preferably alkyl radicals having 1 to 4 carbon atoms, optionally substituted by halogen atoms, especially the methyl or ethyl radical.

In the context of the present invention, polymers on which the polymer radical Y is based are to be understood to mean all polymers in which at least 50%, preferably at least 70%, particularly preferably at least 90%, of all bonds in the main chain are carbon-carbon, carbon-nitrogen or carbon-oxygen bonds.

Examples of polymer radicals Y are polyester, polyether, polyurethane, polyalkylene and polyacrylate radicals.

Polymer radical Y is preferably organic polymer radicals comprising as the polymer chain polyoxyalkylenes such as polyoxyethylene, polyoxypropylene, polyoxybutylene, polyoxytetramethylene, polyoxyethylene-polyoxypropylene copolymer and polyoxypropylene-polyoxybutylene copolymer; hydrocarbon polymers such as polyisobutylene and copolymers of polyisobutylene with isoprene; polychloroprenes; polyisoprenes; polyurethanes; polyesters; polyacrylates; polymethacrylates; vinyl polymer or polycarbonates and which are preferably bonded via —O—C(═O)—NH—, —NH—C(═O)O—, —NH—C(═O)—NH—, —NR′—C(═O)—NH—, NH—C(═O)—NR′—, —NH—C(═O)—, —C(═O)—NH—, —C(═O)—O—, —O—C(═O)—, —O—C(═O)—O—, —S—C(═O)—NH—, —NH—C(═O)—S—, —C(═O)—S—, —S—C(═O)—, —S—C(═O)—S—, —C(═O)—, —S—, —O—, —NR′— to the group or groups —[(CR¹₂)_{b}—SiRₐ(OR²)₃₋ₐ], where R′ may be the same or different and has a definition specified for R or is a group —CH(COOR″)—CH₂—COOR″, in which R″ may be the same or different and has a definition specified for R.

The radical R′ is preferably a —CH(COOR″)—CH₂—COOR″ group or an optionally substituted hydrocarbon radical having 1 to 20 carbon atoms, particularly preferably a linear, branched or cyclic alkyl group having 1 to 20 carbon atoms or an optionally halogen atom-substituted aryl group having 6 to 20 carbon atoms.

Examples of radicals R′ are cyclohexyl, cyclopentyl, n- and isopropyl, n-, iso- and t-butyl radical, the various stereoisomers of the pentyl radical, hexyl radical or heptyl radical and also the phenyl radical.

The radicals R″ are preferably alkyl groups having 1 to 10 carbon atoms, particularly preferably methyl, ethyl or propyl radicals.

The component (A) can have the groups —[(CR¹₂)_{b}—SiRₐ(OR²)₃₋ₐ] attached in the manner described at any positions in the polymer, for example pendently and/or terminally.

Particularly preferably, the radical Y in formula (I) are x-valent organic polymer radicals bonded via nitrogen, oxygen, sulfur or carbon, which comprise polyurethanes or polyoxyalkylenes as polymer chain, in particular polyurethane radicals having terminally attached groups —[(CR¹₂)_{b}—SiRₐ(OR²)₃₋ₐ] or polyoxyalkylene radicals having terminally attached groups —[(CR¹₂)_{b}—SiRₐ(OR²)₃₋ₐ], where the radicals and indices have the definitions specified above. The radicals Y are preferably linear or have 1 to 3 branching points. They are particularly preferably linear.

The polyurethane radicals Y are preferably those of which the chain ends are bonded via —NH—C(═O)O—, —NH—C(═O)—NH—, —NR′—C(═O)—NH— or —NH—C(═O)—NR′—, in particular via —O—C(═O)—NH— or —NH—C(═O)—NR′—, to the group or groups —[(CR¹₂)_{b}—SiRₐ(OR²)₃₋ₐ], where all radicals and indices have one of the definitions specified above. The polyurethane radicals Y can preferably be produced from linear or branched polyoxyalkylenes, in particular from polypropylene glycols, and di- or polyisocyanates. The radicals Y preferably have average molar masses Mₙ (number average) from 400 to 30 000 g/mol, preferably from 4000 to 20 000 g/mol. Suitable methods for preparing a corresponding component (A) and also examples of component (A) itself are described, inter alia, in EP 1 093 482 B1 (paragraphs [0014]-[0023], [0039]-[0055] and example 1 and comparative example 1) or EP 1 641 854 B1 (paragraphs [0014][0035], examples 4 and 6 and comparative examples 1 and 2), which are included in the disclosure content of the present application.

The number-average molar mass Mₙ is determined in the context of the present invention by size-exclusion chromatography (SEC) on a Styragel HR3-HR4-HR5-HR5 column set from Waters Corp. USA in THE with an injected volume of 100 μl against a polystyrene standard and at 60° C., a flow rate of 1.2 ml/min, and detection by RI (refractive index detector).

The polyoxyalkylene radicals Y are preferably linear or branched polyoxyalkylene radicals, particularly preferably polyoxypropylene radicals, the chain ends of which are preferably bonded via —O—C(═O)—NH— or —O— to the group or groups —[(CR¹₂)_{b}—SiRₐ(OR²)₃₋ₐ], where the radicals and indices have one of the definitions given above. Preferably, at least 85%, particularly preferably at least 90%, especially at least 95%, of all chain ends are bonded via —O—C(═O)—NH— to the group —[(CR¹₂)_{b}—SiRₐ(OR²)₃₋ₐ]. The polyoxyalkylene radicals Y preferably have average molar masses Mₙ of 4000 to 30 000 g/mol, preferably 8000 to 20 000 g/mol. Suitable methods for preparing a corresponding component (A) and also examples of component (A) itself are described, inter alia, in EP 1 535 940 B1 (paragraphs [0005]-[0025] and examples 1-3 and comparative example 1-4) or EP 1 896 523 B1 (paragraphs [0008]-[0047], which are included in the disclosure content of the present application.

The end groups of the compounds (A) used according to the invention are preferably those of the general formulae

—NH—C(═O)—NR′—(CR¹₂)_{b}—SiRₐ(OR²)₃₋ₐ (IV),

—O—C(═O)—NH—(CR¹₂)_{b}—SiRₐ(OR²)₃₋ₐ (V)

or

—O—(CR¹₂)_{b}—SiRₐ(OR²)₃₋ₐ (VI),

where the radicals and indices have one of the definitions for them specified above.

If the compounds (A) are polyurethanes, which is preferred, they preferably have one or more of the end groups

—NH—C(═O)—NR′—(CH₂)₃—Si(OCH₃)₃,

—NH—C(═O)—NR′—(CH₂)₃—Si(OC₂H₅)₃,

—O—C(═O)—NH—(CH₂)₃—Si(OCH₃)₃ or

—O—C(═O)—NH—(CH₂)₃—Si(OC₂H₅)₃,

where R′ has the definition stated above.

If the compounds (A) are polypropylene glycols, which is particularly preferred, they preferably have one or more of the end groups

—O—(CH₂)₃—Si(CH₃)(OCH₃)₂,

—O—(CH₂)₃—Si(OCH₃)₃,

—O—C(═O)—NH—(CH₂)₃—Si(OC₂H₅)₃,

—O—C(═O)—NH—CH₂—Si(CH₃)(OC₂H₅)₂,

—O—C(═O)—NH—CH₂—Si(OCH₃)₃,

—O—C(═O)—NH—CH₂—Si(CH₃)(OCH₃)₂ or

—O—C(═O)—NH—(CH₂)₃—Si(OCH₃)₃,

where the latter two end groups are particularly preferred.

The average molecular weights Mₙ of the compounds (A) are preferably at least 400 g/mol, particularly preferably at least 4000 g/mol, especially at least 10 000 g/mol, and preferably at most 30 000 g/mol, particularly preferably at most 20 000 g/mol, especially at most 19 000 g/mol.

The viscosity of the compounds (A) is preferably at least 0.2 Pas, preferably at least 1 Pas, particularly preferably at least 5 Pas, and preferably at most 700 Pas, preferably at most 100 Pas, measured in each case at 20° C.

In the context of the present invention, the viscosity of the polymers (A) used according to the invention is determined in accordance with ISO 2555 after heating to 23° C. with a DV 3 P rotational viscometer from A. Paar (Brookfield system) using spindle 5 at 2.5 rpm.

The compounds (A) used according to the invention are commercially available products or can be prepared by standard chemical processes.

The polymers (A) can be prepared by known methods such as addition reactions, e.g. hydrosilylation, Michael addition, Diels-Alder addition or reactions between isocyanate-functional compounds with compounds having isocyanate-reactive groups.

The component (A) used according to the invention may comprise only one type of compound of the formula (I) and also mixtures of different types of compounds of the formula (I). The component (A) may comprise exclusively compounds of the formula (I) in which more than 90%, preferably more than 95% and particularly preferably more than 98% of all the silyl groups bonded to the radical Y are identical. However, it is then also possible to use a component (A) which at least in part comprises compounds of the formula (I) in which different silyl groups are bonded to a radical Y. Finally, mixtures of different compounds of the formula (I) may also be used as component (A), in which a total of at least 2 different types of silyl groups bonded to radicals Y are present, but where all silyl groups bonded to a respective radical Y are identical.

Examples of metal soaps (B) are calcium and aluminum stearates.

Heat-activatable thixotropic agents selected from fatty acid amides, polyamide waxes, polyamide wax derivatives, hydrogenated castor oil and hydrogenated castor oil derivatives are preferred as component (B), where fatty acid amides, polyamide waxes and polyamide wax derivatives are particularly preferred. Component (B) is particularly preferably a polyamide wax or polyamide wax derivative, especially preferably a polyamide wax.

The melting points of the thixotropic agents (B) are preferably between 40° C. and 200° C., particularly preferably between 50° C. and 150° C., particularly preferably between 60 and 150° C., in each case at 1013 mbar.

In the process according to the invention, all process steps starting with the mixing of components (A) and (B), the optional simultaneous or subsequent mixing in of further components and also optional further process steps and the storage of the finished composition (M) including transport thereof up until use thereof are preferably carried out at temperatures which are at least 30° C., particularly preferably at least 40° C., especially at least 50° C. below the melting point of the component (B) used, whereby, if two or more thixotropic agents (B) are used, this specification refers to that thixotropic agent (B) having the highest melting point. All process steps are preferably carried out at temperatures of at least −20° C., regardless of the melting temperature of component (B). All process steps with the exception of storage are preferably carried out at temperatures of at least 0° C., particularly preferably at least 10° C. and especially preferably at least 15° C.

Commercially available examples of suitable thixotropic agents (B) are those with the trade name Disparlon® 6500 (polyamide wax having a melting point of ca. 123° C. from Kusumoto Chemicals Ltd), Crayvallac® SLT (polyamide wax having a melting point of 117-127° C. from Arkema) or Crayvallac® SLX (polyamide wax having a melting point of 117-127° C. from Arkema).

Component (B) is preferably used in amounts of 1 to 50 parts by weight, particularly preferably in amounts of 3 to 40 parts by weight, based in each case on 100 parts by weight of component (A).

In addition to the components (A) and (B) used, the compositions (M) produced according to the invention may comprise all other substances which have also been used to date in crosslinkable compositions and which differ from components (A) and (B), such as those selected from the group consisting of nitrogen-containing organosilicon compounds (C), non-reactive plasticizers (D), fillers (E), silicone resins (F), catalysts (G), adhesion promoters (H), water scavengers (I), additives (J) and additional materials (K).

Component (C) optionally used is preferably organosilicon compounds comprising units of the formula

DₑSi(OR⁴)_{d}R³_{c}O_{(4-c-d-e)/2} (II),
where
R³ may be the same or different and is a monovalent, optionally substituted SiC-bonded, nitrogen-free organic radical,
R⁴ may be the same or different and is a hydrogen atom or optionally substituted hydrocarbon radicals,
D may be the same or different and is a monovalent, SiC-bonded radical having at least one nitrogen atom not bonded to a carbonyl group (C═O),
c is 0, 1, 2 or 3, preferably 0 or 1,
d is 0, 1, 2 or 3, preferably 1, 2 or 3, particularly preferably 2 or 3, and
e is 0, 1, 2, 3 or 4, preferably 1,
with the proviso that the sum of c+d+e is less than or equal to 4 and at least one radical D is present per molecule.

The organosilicon compounds (C) optionally used according to the invention can be both silanes, i.e. compounds of the formula (II) where c+d+e=4, and siloxanes, i.e. compounds comprising units of the formula (II) where c+d+e≤3, preference being given to silanes.

Examples of radical R³ are the examples given for R.

Radical R³ is preferably hydrocarbon radicals having 1 to 18 carbon atoms optionally substituted by halogen atoms, particularly preferably hydrocarbon radicals having 1 to 5 carbon atoms, especially the methyl radical.

Examples of optionally substituted hydrocarbon radicals R⁴ are the examples given for radical R.

Radicals R⁴ are preferably hydrogen atoms or hydrocarbon radicals having 1 to 18 carbon atoms optionally substituted by halogen atoms, particularly preferably hydrogen atoms or hydrocarbon radicals having 1 to 10 carbon atoms, especially methyl or ethyl radicals.

Examples of radical D are radicals of the formulae H₂N(CH₂)₃—, H₂N(CH₂)₂NH(CH₂)₃—, H₂N(CH₂)₂NH(CH₂)₂NH(CH₂)₃—, H₃CNH(CH₂)₃—, C₂H₅NH(CH₂)₃—, C₃H₇NH(CH₂)₃—, C₄H₉NH(CH₂)₃—, C₅H₁₁NH(CH₂)₃—, C₆H₁₃NH(CH₂)₃—, C₇H₁₅NH(CH₂)₃—, H₂N(CH₂)₄—, H₂N—CH₂—CH(CH₃)—CH₂—, H₂N(CH₂)₅—, cyclo-C₅H₉NH(CH₂)₃—, cyclo-C₆H₁₁NH(CH₂)₃—, phenyl-NH(CH₂)₃—, (CH₃)₂N(CH₂)₃—, (C₂H₅)₂N(CH₂)₃—, (C₃H₇)₂N(CH₂)₃—, (C₄H₉)₂N(CH₂)₃—, (C₅H₁₁)₂N(CH₂)₃—, (C₆H₁₃)₂N(CH₂)₃—, (C₇H₁₅)₂N(CH₂)₃—, H₂N(CH₂)—, H₂N(CH₂)₂NH(CH₂)—, H₂N(CH₂)₂NH(CH₂)₂NH(CH₂)—, H₃CNH(CH₂)—, C₂H₅NH(CH₂)—, C₃H₇NH(CH₂)—, C₄H₉NH(CH₂)—, C₅H₁₁NH(CH₂)—, C₆H₁₃NH(CH₂)—, C₇H₁₅NH(CH₂)—, cyclo-C₅H₉NH(CH₂)—, cyclo-C₆H₁₁NH(CH₂)—, phenyl-NH(CH₂)—, (CH₃)₂N(CH₂)—, (C₂H₅)₂N(CH₂)—, (C₃H₇)₂N(CH₂)—, (C₄H₉)₂N(CH₂)—, (C₅H₁₁)₂N(CH₂)—, (C₆H₁₃)₂N(CH₂)—, (C₇H₁₅)₂N(CH₂)—, (CH₃O)₃Si(CH₂)₃NH(CH₂)₃—, (C₂H₅₀)₃Si(CH₂)₃NH(CH₂)₃—, (CH₃O)₂(CH₃)Si(CH₂)₃NH(CH₂)₃— and (C₂H₅₀)₂(CH₃)Si(CH₂)₃NH(CH₂)₃— and reaction products of the aforementioned primary amino groups with compounds comprising double bonds or epoxide groups reactive to primary amino groups.

The radical D is preferably the H₂N(CH₂)₃—, H₂N(CH₂)₂NH(CH₂)₃— or cyclo-C₆H₁₁NH(CH₂)₃— radical.

Examples of the silanes of the formula (II) optionally used according to the invention are H₂N(CH₂)₃—Si(OCH₃)₃, H₂N(CH₂)₃—Si(OC₂H₅)₃, H₂N(CH₂)₃—Si(OCH₃)₂CH₃, H₂N(CH₂)₃—Si(OC₂H₅)₂CH₃, H₂N(CH₂)₂NH(CH₂)₃—Si(OCH₃)₃, H₂N(CH₂)₂NH(CH₂)₃—Si(OC₂H₅)₃, H₂N(CH₂)₂NH(CH₂)₃—Si(OCH₃)₂CH₃, H₂N(CH₂)₂NH(CH₂)₃—Si(OC₂H₅)₂CH₃, H₂N(CH₂)₂NH(CH₂)₃—Si(OH)₃, H₂N(CH₂)₂NH(CH₂)₃—Si(OH)₂CH₃, H₂N(CH₂)₂NH(CH₂)₂NH(CH₂)₃—Si(OCH₃)₃, H₂N(CH₂)₂NH(CH₂)₂NH(CH₂)₃—Si(OC₂H₅)₃, cyclo-C₆H₁₁NH(CH₂)₃—Si(OCH₃)₃, cyclo-C₆H₁₁NH(CH₂)₃—Si(OC₂H₅)₃, cyclo-C₆H₁₁NH(CH₂)₃—Si(OCH₃)₂CH₃, cyclo-C₆H₁₁NH(CH₂)₃—Si(OC₂H₅)₂CH₃, cyclo-C₆H₁₁NH(CH₂)₃—Si(OH)₃, cyclo-C₆H₁₁NH(CH₂)₃—Si(OH)₂CH₃, phenyl-NH(CH₂)₃—Si(OCH₃)₃, phenyl-NH(CH₂)₃—Si(OC₂H₅)₃, phenyl-NH(CH₂)₃—Si(OCH₃)₂CH₃, phenyl-NH(CH₂)₃—Si(OC₂H₅)₂CH₃, phenyl-NH(CH₂)₃—Si(OH)₃, phenyl-NH(CH₂)₃—Si(OH)₂CH₃, HN((CH₂)₃—Si(OCH₃)₃)₂, HN((CH₂)₃—Si(OC₂H₅)₃)₂ HN((CH₂)₃—Si(OCH₃)₂CH₃)₂, HN((CH₂)₃—Si(OC₂H₅)₂CH₃)₂, cyclo-C₆H₁₁NH(CH₂)—Si(OCH₃)₃, cyclo-C₆H₁₁NH(CH₂)—Si(OC₂H₅)₃, cyclo-C₆H₁₁NH(CH₂)—Si(OCH₃)₂CH₃, cyclo-C₆H₁₁NH(CH₂)—Si(OC₂H₅)₂CH₃, cyclo-C₆H₁₁NH(CH₂)—Si(OH)₃, cyclo-C₆H₁₁NH(CH₂)—Si(OH)₂CH₃, phenyl-NH(CH₂)—Si(OCH₃)₃, phenyl-NH(CH₂)—Si(OC₂H₅)₃, phenyl-NH(CH₂)—Si(OCH₃)₂CH₃, phenyl-NH(CH₂)—Si(OC₂H₅)₂CH₃, phenyl-NH(CH₂)—Si(OH)₃ and phenyl-NH(CH₂)—Si(OH)₂CH₃ and partial hydrolysates thereof, where preference is given to H₂N(CH₂)₂NH(CH₂)₃—Si(OCH₃)₃, H₂N(CH₂)₂NH(CH₂)₃—Si(OC₂H₅)₃, H₂N(CH₂)₂NH(CH₂)₃—Si(OCH₃)₂CH₃, cyclo-C₆H₁₁NH(CH₂)₃—Si(OCH₃)₃, cyclo-C₆H₁₁NH(CH₂)₃—Si(OC₂H₅)₃ and cyclo-C₆H₁₁NH(CH₂)₃—Si(OCH₃)₂CH₃ and partial hydrolysates thereof in each case and particular preference is given to H₂N(CH₂)₂NH(CH₂)₃—Si(OCH₃)₃, H₂N(CH₂)₂NH(CH₂)₃—Si(OCH₃)₂CH₃, cyclo-C₆H₁₁NH(CH₂)₃—Si(OCH₃)₃, cyclo-C₆H₁₁NH(CH₂)₃—Si(OCH₃)₂CH₃ and partial hydrolysates thereof in each case.

The organosilicon compounds (C) optionally used according to the invention may also assume the function of a curing catalyst or co-catalyst in the compositions (M) produced according to the invention.

Furthermore, the organosilicon compounds (C) optionally used according to the invention may act as adhesion promoters and/or as water scavengers.

The organosilicon compounds (C) optionally used according to the invention are commercial products or can be produced by standard chemical methods.

If the compositions (M) produced according to the invention comprise component (C), the amounts involved are preferably 0.1 to 25 parts by weight, particularly preferably 0.2 to 20 parts by weight, especially 0.5 to 15 parts by weight, based in each case on 100 parts by weight of component (A). Component (C) is preferably used in the method according to the invention.

Non-reactive plasticizers (D) optionally used may be all non-reactive plasticizers which have hitherto also been used in crosslinkable organopolysiloxane compositions.

The non-reactive plasticizers (D) are preferably organic compounds selected from the substance groups consisting of
fully esterified aromatic or aliphatic carboxylic acids,
fully esterified derivatives of phosphoric acid,
fully esterified derivatives of sulfonic acids,
branched or unbranched saturated hydrocarbons,
polystyrenes,
polybutadienes,
polyisobutylenes,
polyesters or
polyethers.

The non-reactive plasticizers (D) optionally used according to the invention are preferably those which react neither with water nor with components (A) and (B) at temperatures <80° C., are liquid at 20° C. and 1013 hPa and have a boiling point >250° C. at 1013 hPa.

Examples of the carboxylic acid esters (D) are phthalic acid esters such as dioctyl phthalate, diisooctyl phthalate, diisononyl phthalate, diisodecyl phthalate and diundecyl phthalate; perhydrogenated phthalic acid esters such as diisononyl 1,2-cyclohexanedicarboxylate and dioctyl 1,2-cyclohexanedicarboxylate; adipic acid esters such as dioctyl adipate; benzoic acid esters; esters of trimellitic acid, glycol esters; esters of saturated alkanediols such as 2,2,4-trimethyl-1,3-pentanediol monoisobutyrate and 2,2,4-trimethyl-1,3-pentanediol diisobutyrate.

Examples of polyethers (D) are polyethylene glycols, poly-THF and polypropylene glycols having molar masses of preferably 200 to 20 000 g/mol.

Plasticizers (D) used are preferably those having molar masses or, in the case of polymeric plasticizers, average molar masses Mₙ, of at least 200 g/mol, particularly preferably greater than 500 g/mol, especially greater than 900 g/mol. They preferably have molar masses or average molar masses Mₙ of at most 20 000 g/mol, particularly preferably of at most 10 000 g/mol, especially at most 8000 g/mol.

In a preferred embodiment of the invention, the component (D) used are phthalic acid ester-free plasticizers, such as perhydrogenated phthalic acid esters, esters of trimellitic acid, polyesters or polyethers. Plasticizers (D) are particularly preferably polyethers, in particular polyethylene glycols, poly-THF and polypropylene glycols, especially preferably polypropylene glycols. The preferred polyethers (D) have molar masses preferably between 400 and 20 000 g/mol, particularly preferably between 800 and 12 000 g/mol, especially between 1000 and 8000 g/mol.

If non-reactive plasticizers (D) are used according to the invention, the amounts involved are preferably 5 to 300 parts by weight, particularly preferably 10 to 200 parts by weight, especially 20 to 150 parts by weight, based in each case on 100 parts by weight of component (A). Plasticizers (D) are preferably used in the method according to the invention.

The fillers (E) optionally used according to the invention can be any fillers known to date.

Examples of fillers (E) are non-reinforcing fillers, i.e. fillers having a BET surface area of preferably up to 50 m²/g, such as quartz, diatomaceous earth, calcium silicate, zirconium silicate, talc, kaolin, zeolites, metal oxide powders such as oxides of aluminum, titanium, iron or zinc or mixed oxides thereof, barium sulfate, calcium carbonate, gypsum, silicon nitride, silicon carbide, boron nitride, glass and plastic powders such as polyacrylonitrile powder; reinforcing fillers, i.e. fillers having a BET surface area of more than 50 m²/g, such as fumed silica, precipitated silica, precipitated chalk and silicon-aluminum mixed oxides, carbon black, such as furnace and acetylene black having a large BET surface area; aluminum trihydroxide, hollow spherical fillers such as ceramic microspheres, elastic plastic beads, glass beads or fibrous fillers. The fillers mentioned may be hydrophobized, for example by treatment with organosilanes or organosiloxanes or with stearic acid or by etherification of hydroxyl groups to alkoxy groups.

The fillers (E) optionally used are preferably calcium carbonate, magnesium carbonate and/or calcium-magnesium mixed carbonates, talc, aluminum trihydroxide and silica. Preferred calcium carbonate grades are ground or precipitated and optionally surface-treated with fatty acids such as stearic acid or salts thereof. The preferred silica is preferably fumed silica.

Fillers (E) optionally used have a moisture content of preferably less than 1% by weight, particularly preferably less than 0.5% by weight.

If fillers (E) are used according to the invention, the amounts involved are preferably 10 to 1000 parts by weight, particularly preferably 40 to 500 parts by weight, especially 80 to 300 parts by weight, based in each case on 100 parts by weight of constituent (A). Fillers (E) are preferably used in the method according to the invention.

In a particularly preferred embodiment of the method according to the invention, calcium carbonate, magnesium carbonate and/or calcium-magnesium mixed carbonates are used as filler (E1) in amounts of 10 to 900 parts by weight, particularly preferably 40 to 450 parts by weight, especially 80 to 280 parts by weight, based in each case on 100 parts by weight of constituent (A). In addition to the fillers (E1), preferably in the amounts stated, other fillers (E2) different from (E1) may also be present. The same materials which have already been described above as fillers (E) can be used as fillers (E2), provided these do not fall under the definition of (E1). The preferred total amounts of fillers (E1) and (E2) correspond to the preferred amounts for fillers (E) stated above.

The silicone resins (F) optionally used in the compositions (M) according to the invention are preferably phenyl silicone resins.

The silicone resins (F) optionally used according to the invention are particularly preferably those which consist to an extent of at least 50% by weight, preferably at least 70% by weight, especially at least 90% by weight, of T units of the formulae PhSiO_{3/2}, PhSi(OR⁵)O_{2/2}, PhSi(OR⁵)₂O_{1/2}, MeSiO_{3/2}, MeSi(OR⁵)O_{2/2} and/or MeSi(OR⁵)₂O_{1/2}, where Ph is phenyl radical, Me is the methyl radical and R⁵ is a hydrogen atom or alkyl radicals having 1 to 10 carbon atoms optionally substituted by halogen atoms, preferably unsubstituted alkyl radicals having 1 to 4 carbon atoms, based in each case on the total number of units. These resins preferably consist of at least 30% by weight, particularly preferably at least 40% by weight, of the three aforementioned units having a PhSi function.

The silicone resins (F) optionally used according to the invention are particularly preferably those which comprise at least 50% by weight, preferably at least 70% by weight, especially at least 90% by weight, of T units of the formulae PhSiO_{3/2}, PhSi(OR⁵)O_{2/2} and/or PhSi(OR⁵)₂O_{1/2}, with all variables having the definition stated above.

The silicone resins (F) optionally used according to the invention preferably have an average molar mass (number average) Mₙ of at least 400 g/mol and particularly preferably of at least 600 g/mol. The average molar mass Mₙ of the silicone resins (F) is preferably at most 400 000 g/mol, particularly preferably at most 10 000 g/mol, especially at most 3000 g/mol.

The silicone resins (F) optionally used according to the invention can be both solid and liquid at 23° C. and 1000 hPa, silicone resins (F) being preferably liquid. The silicone resins (F) preferably have a viscosity of 10 to 100 000 mPas, preferably 50 to 50 000 mPas, especially from 100 to 20 000 mPas, in each case at 25° C.

The silicone resins (F) can be used either in pure form or in the form of a mixture in a suitable solvent, although use in pure form is preferred.

Examples of phenyl silicone resins that may be used as component (F) are commercially available products, for example various SILRES® types from Wacker Chemie AG, such as SILRES® IC 368, SILRES® IC 678 or SILRES® IC 231 and SILRES® SY231.

If resins (F) are used to produce the compositions (M) according to the invention, the amounts are preferably at least 1 part by weight, particularly preferably at least 5 parts by weight, especially at least 10 parts by weight and preferably at most 1000 parts by weight, particularly preferably at most 500 parts by weight, especially at most 300 parts by weight, based in each case on 100 parts by weight of component (A).

The catalysts (G) optionally used in the compositions (M) according to the invention may be any catalysts known to date for compositions which cure by silane condensation.

Examples of metal-containing curing catalysts (G) are organic titanium and tin compounds, for example, titanic acid esters such as tetrabutyl titanate, tetrapropyl titanate, tetraisopropyl titanate and titanium tetraacetylacetonate; tin compounds such as dibutyltin dilaurate, dibutyltin maleate, dibutyltin diacetate, dibutyltin dioctanoate, dibutyltin acetylacetonate, dibutyltin oxides, and corresponding dioctyltin compounds.

Examples of metal-free curing catalysts (G) are basic compounds such as triethylamine, tributylamine, 1,4-diazabicyclo[2.2.2]octane, 1,5-diazabicyclo[4.3.0]non-5-ene, 1,8-diazabicyclo[5.4.0]undec-7-ene, 1,1,2,2-tetramethylguanidine, 1,1,2,3-tetramethylguanidine, N,N-bis(N,N-dimethyl-2-aminoethyl) methylamine, N,N-dimethylcyclohexylamine, N,N-dimethylphenylamine and N-ethylmorpholinine.

Acidic compounds may also be used as catalyst (G), such as phosphoric acid and partially esterified derivatives thereof, toluenesulfonic acid, sulfuric acid, nitric acid or else organic carboxylic acids, for example acetic acid and benzoic acid.

If catalysts (G) are used according to the invention, the amounts involved are preferably 0.01 to 20 parts by weight, particularly preferably 0.05 to 5 parts by weight, based in each case on 100 parts by weight of constituent (A).

In one embodiment of the invention, the catalysts (G) optionally used are metal-containing curing catalysts, preferably tin-containing catalysts. This embodiment of the invention is particularly preferred when the component (A) consists entirely or at least partially, i.e. to an extent of at least 90% by weight, preferably to an extent of at least 95% by weight, of compounds of the formula (I) in which b is not equal to 1.

To prepare the compositions (M) according to the invention, metal-containing catalysts (G), and in particular tin-containing catalysts, can preferably be dispensed with if component (A) consists entirely or at least partly, i.e. to an extent of at least 10% by weight, preferably to an extent of at least 20% by weight, of compounds of the formula (I) in which b is equal to 1 and R¹ has the definition of a hydrogen atom. This embodiment of the invention without metal-containing catalysts and in particular without tin-containing catalysts is particularly preferred.

The adhesion promoters (H) optionally used according to the invention can be any adhesion promoters previously described for systems curing by means of silane condensation.

Examples of adhesion promoters (H) are epoxysilanes, such as glycidoxypropyltrimethoxysilanes, glycidoxypropylmethyldimethoxysilane, glycidoxypropyltriethoxysilane or glycidoxypropylmethyldiethoxysilane, 2-(3-triethoxysilylpropyl)maleic anhydride, N-(3-trimethoxysilylpropyl)urea, N-(3 triethoxysilylpropyl)urea, N-(trimethoxysilylmethyl)urea, N-(methyldimethoxysilylmethyl)urea, N-(3-triethoxysilylmethyl)urea, N-(3-methyldiethoxysilylmethyl)urea, O-methylcarbamatomethylmethyldimethoxysilane, O-methylcarbamatomethyltrimethoxysilane, O-ethylcarbamatomethylmethyldiethoxysilane, O-ethylcarbamatomethyltriethoxysilane, 3-methacryloxypropyltrimethoxysilane, methacryloxymethyltrimethoxysilane, methacryloxymethylmethyldimethoxysilane, methacryloxymethyltriethoxysilane, methacryloxymethylmethyldiethoxysilane, 3-acryloxypropyltrimethoxysilane, acryloxymethyltrimethoxysilane, acryloxymethylmethyldimethoxysilanes, acryloxymethyltriethoxysilane, acryloxymethylmethyldiethoxysilane and partial condensates thereof.

If adhesion promoters (H) are used in the method according to the invention, the amounts involved are preferably 0.5 to 30 parts by weight, particularly preferably 1 to 10 parts by weight, based in each case on 100 parts by weight of crosslinkable composition (M).

The water scavengers (I) optionally used in the method according to the invention can be any water scavengers described for systems curing by means of silane condensation.

Examples of water scavengers (I) are silanes such as vinyltrimethoxysilane, vinyltriethoxysilane, vinylmethyldimethoxysilane, phenyltrimethoxysilane, phenyltriethoxysilane, phenylmethyldimethoxysilane, tetraethoxysilane, O-methylcarbamatomethylmethyldimethoxysilane, O-methylcarbamatomethyltrimethoxysilane, O-ethylcarbamatomethylmethyldiethoxysilane, O-ethylcarbamatomethyltriethoxysilane, and/or partial condensates thereof and orthoesters such as 1,1,1-trimethoxyethane, 1,1,1-triethoxyethane, trimethoxymethane and triethoxymethane, with vinyltrimethoxysilane being preferred.

If the compositions (M) produced according to the invention comprise water scavengers (I), this involves amounts of preferably 0.5 to 30 parts by weight, particularly preferably 1 to 10 parts by weight, based in each case on 100 parts by weight of crosslinkable composition (M). Water scavengers (I) are preferably used in the method according to the invention.

The additives (J) optionally used according to the invention can be any additives known to date that are typical for silane crosslinking systems.

The additives (J) optionally used according to the invention are compounds that differ from the components mentioned so far, preferably antioxidants, UV stabilizers, such as so-called HALS compounds, fungicides, commercially available defoamers, for example from BYK (D-Wesel), commercially available wetting agents, for example from BYK (D-Wesel) or pigments.

If additives (J) are used for the preparation of the compositions (M) according to the invention, which is preferred, the amounts involved are preferably from 0.01 to 30 parts by weight, particularly preferably from 0.1 to 10 parts by weight, based in each case on 100 parts by weight of constituent (A).

The additional materials (K) optionally used according to the invention are preferably tetraalkoxysilanes, for example tetraethoxysilane, and/or partial condensates thereof, reactive plasticizers, rheology additives different from component (B), flame retardants or organic solvents.

Preferred reactive plasticizers (K) are compounds which comprise alkyl chains having 6 to 40 carbon atoms and have a group which is reactive to the compounds (A). Examples are isooctyltrimethoxysilane, isooctyltriethoxysilane, N-octyltrimethoxysilane, N-octyltriethoxysilane, decyltrimethoxysilane, decyltriethoxysilane, dodecyltrimethoxysilane, dodecyltriethoxysilane, tetradecyltrimethoxysilane, tetradecyltriethoxysilane, hexadecyltrimethoxysilane and hexadecyltriethoxysilane.

All flame retardants typical of adhesive and sealant systems can be used as flame retardants (K), preferably halogenated compounds and (partial) esters of phosphoric acid and derivatives thereof, in particular (partial) esters of phosphoric acid.

Examples of organic solvents (K) are low molecular weight ethers, esters, ketones, aromatic and aliphatic and optionally halogen-containing hydrocarbons and alcohols, preference being given to the latter.

Preferably no organic solvents (K) are added to the compositions (M) according to the invention.

If one or more components (K) are used to prepare the compositions (M) according to the invention, the amounts involved in each case are preferably 0.5 to 200 parts by weight, particularly preferably 1 to 100 parts by weight, especially 2 to 70 parts by weight, based in each case on 100 parts by weight of component (A).

In a preferred embodiment of the method according to the invention
(A) 100 parts by weight of compounds of the formula (I),
(B) 0.1-50 parts by weight of thixotropic agent,
(C) 0.1-25 parts by weight of organosilicon compounds comprising units of the formula (II),
optionally (D) non-reactive plasticizers,
optionally (E) fillers,
optionally (F) silicone resins
optionally (G) catalysts,
optionally (H) adhesion promoters,
optionally (I) water scavengers,
optionally (J) additives and
optionally (K) additional materials
   are mixed together and then the resulting mixture is stored for at least 7 days, all process steps being carried out at temperatures below 80° C.

In a further preferred embodiment of the method according to the invention
(A) 100 parts by weight of compounds of the formula (I),
(B) 1-40 parts by weight of thixotropic agent,
(C) 0.1-25 parts by weight of organosilicon compounds comprising units of the formula (II),
optionally (D) non-reactive plasticizers,
(E) 10-1000 parts by weight of fillers,
optionally (F) silicone resins,
optionally (G) catalysts,
optionally (H) adhesion promoters,
optionally (I) water scavengers,
optionally (J) additives and
optionally (K) additional materials
   are mixed together and then the resulting mixture is stored for at least 7 days, all process steps being carried out at temperatures below 80° C.

In a particularly preferred embodiment of the method according to the invention
(A) 100 parts by weight of compounds of the formula (I),
(B) 1-40 parts by weight of thixotropic agent,
(C) 0.1-25 parts by weight of organosilicon compounds comprising units of the formula (II),
(D) 10-300 parts by weight of non-reactive plasticizers,
(E) 10-1000 parts by weight of fillers,
optionally (F) silicone resins,
optionally (G) catalysts,
optionally (H) adhesion promoters,
optionally (I) water scavengers,
optionally (J) additives and
optionally (K) additional materials
   are mixed together and then the resulting mixture is stored for at least 7 days, all process steps being carried out at temperatures below 80° C.

In a further particularly preferred embodiment of the method according to the invention
(A) 100 parts by weight of compounds of the formula (I),
(B) 1-40 parts by weight of thixotropic agent,
(C) 0.1-25 parts by weight of organosilicon compounds comprising units of the formula (II),
(F) 10-200 parts by weight of plasticizer,
(E1) 10-800 parts by weight of calcium carbonate, magnesium carbonate and/or calcium-magnesium mixed carbonates, optionally fillers (E2) that differ from components (E1),
optionally (F) silicone resins,
optionally (G) catalysts,
optionally (H) adhesion promoters,
optionally (I) water scavengers,
optionally (J) additives and
optionally (K) additional materials
   are mixed together and then the resulting mixture is stored for at least 7 days, all process steps being carried out at temperatures below 80° C.

The components used according to the invention may each be one type of such a component or else a mixture of at least two types of a respective component.

In the method according to the invention, preference is given to using no components beyond components (A) to (K).

The compositions (M) produced according to the invention are preferably pasty compositions. After storage for 21 days at 23° C., these preferably have a viscosity determined according to DIN 54458 at 25° C. and a 0.1% deformation of 100 to 100 000 Pas, particularly preferably 1000 to 50 000 Pas, especially from 2000 to 30 000 Pas.

In the method according to the invention, filling is preferably carried out at a time when the composition (M) at 25° C. has a viscosity measured in accordance with DIN 54458 with a deformation of 100% which is at least a factor of 1.5, preferably at least a factor of 2, particularly preferably at least a factor of 3 below the viscosity measured under identical conditions which the same composition (M) has reached after storage of 21 days at 23° C. after preparation thereof.

In a further preferred variant of the method according to the invention, filling is carried out at a time when the composition (M) at 25° C. has a viscosity measured in accordance with DIN 54458 with a deformation of 0.1% which is at least a factor of 2, preferably at least a factor of 3, particularly preferably at least a factor of 4, especially preferably at least a factor of 5 below the viscosity measured under identical conditions which the same composition (M) has reached after storage of 21 days at 23° C. after preparation thereof.

Preferably, after filling into the container (GB), the crosslinkable composition (M) is heated to temperatures below 69° C. at most, particularly preferably to temperatures below 59° C. at most, especially preferably to temperatures below 49° C. at most.

In a preferred embodiment of the invention, after filling into the container (GB), the crosslinkable composition (M) is not heated by any heating device to temperatures above 45° C., particularly preferably to temperatures above 35° C., especially to temperatures above 25° C.

In this preferred embodiment, however, storage temperatures above the limits stated may occur if these are reached without a heating device, for example due to high external temperatures and/or ambient temperatures during storage and/or transport.

The method according to the invention may be carried out continuously or discontinuously.

The compositions (M) produced according to the invention are preferably one-component crosslinkable compositions. However, the compositions (M) produced according to the invention can also be part of two-component crosslinking systems in which OH-containing compounds, such as water, are added in a second component.

The compositions (M) produced according to the invention can be stored if water is excluded and can be crosslinked if water is allowed to enter.

The compositions (M) produced according to the invention may be used for all purposes for which crosslinkable compositions based on organosilicon compounds have also been used hitherto, such as for the production of molded articles by crosslinking and for the production of material composites.

The usual water content of air is sufficient for the crosslinking of the compositions (M) prepared according to the invention. The compositions (M) according to the invention are preferably crosslinked at room temperature. They may, if desired, also be crosslinked at temperatures higher or lower than room temperature, for example at 5° C. to 15° C. or at 30° C. to 50° C. and/or using concentrations of water exceeding the normal water content of air.

The molded articles produced according to the invention preferably have a tensile strength of at least 1.0 MPa, particularly preferably at least 1.5 MPa, measured in each case according to DIN EN 53504-S1.

The molded articles produced according to the invention preferably have an elongation at break of at least 100%, particularly preferably at least 200%, measured in each case according to DIN EN 53504-S1.

The molded articles produced according to the invention may be any molded articles, such as seals, pressed articles, extruded profiles, coatings, impregnations, potting, lenses, prisms, polygonal structures, laminate layers or adhesive layers.

Examples include joint seals, coatings, potting, the production of molded articles, composite materials and composite molded parts. Composite molded parts are to be understood here as meaning a uniform molded article made of a composite material which is composed of a crosslinking product of the compositions (M) according to the invention and at least one substrate such that there is a firm, permanent bond between the two parts.

In the production of material composites, the composition (M) produced according to the invention can also be vulcanized between at least two identical or different substrates, such as in the case of adhesive bonds, laminates or encapsulations.

Examples of substrates that can be bonded or sealed according to the invention are plastics including PVC, metals, concrete, wood, mineral substrates, glass, ceramics and painted surfaces.

The compositions (M) produced according to the invention can be used for all purposes for which it is possible to use compositions which are storable with the exclusion of water and crosslink to give elastomers on ingress of water at room temperature.

The method according to the invention has the advantage that the compositions (M) according to the invention can be produced easily and, because the heating step is no longer necessary, also particularly rapidly and with low energy consumption.

The method according to the invention has the further advantage that the compositions (M) can be filled rapidly into the respective containers for end use, since this filling can take place at viscosities that are significantly lower than at the time of the respective end use. This is particularly advantageous if highly viscous and/or highly thixotropic compositions are required or at least desired for the end use.

The crosslinkable compositions (M) produced according to the invention have the advantage that they are characterized by very high storage stability and a high crosslinking rate.

Furthermore, the crosslinkable compositions (M) produced according to the invention have the advantage that they have an excellent adhesion profile.

Furthermore, the crosslinkable compositions (M) produced according to the invention have the advantage that they are easy to process.

Unless otherwise stated, all steps in the examples below are carried out at a pressure of the ambient atmosphere, i.e. at 1013 hPa, and at room temperature, i.e. at 23° C., or at a temperature that arises when the reactants are combined at room temperature without additional heating or cooling. The crosslinking of the compositions (M) is carried out at a relative humidity of 50%. In addition, unless otherwise stated, all reported parts and percentages relate to weight.

### EXAMPLE 1: PREPARATION OF AN ELASTIC ADHESIVE FORMULATION

180 g of a polypropylene glycol silane-terminated on both sides having an average molar mass (Mₙ) of 18 000 g/mol and end groups of the formula —O—C(═O)—NH—(CH₂)₃—Si(OCH₃)₃ (commercially available under the name GENIOSIL® STP-E35 from Wacker Chemie AG, D-Munich) are homogenized in a laboratory planetary mixer from PC-Laborsystem, equipped with a cross-arm mixer and a dissolver, for 2 minutes with the cross-arm mixer at 200 rpm at ca. 25° C., with 250 g of diisoundecyl phthalate as plasticizer, 224 g of a precipitated chalk coated with fatty acid having an average particle diameter (D50%) of ca. 0.07 μm (commercially available under the name Hakuenka® CCR S10 from Shiraishi Omya GmbH, AT-Gummern), 224 g of a calcium carbonate coated with stearic acid having an average particle diameter (D50%) of ca. 2.0 μm (commercially available under the name Omyabond 520 from Omya, D-Cologne), 40 g of a titanium dioxide having a TiO₂ content >92.0%, a standard classification according to DIN EN ISO 591 of R2, the color index Pigment White 6, and a bulk density of 3.9 kg/I and an oil absorption of 19 g/100 g (commercially available under the name Kronos® 2360 from Kronos, USA Dallas) and 40 g of a micronized polyamide wax having a melting point of 117-127° C. (commercially available under the name Crayvallac® SLX from Arkema, France). The mixture is then stirred for 15 minutes at 600 rpm with the cross-arm mixer and 1000 rpm with the dissolver. The mixture heats up to ca. 43° C. due to the stirring energy introduced. It is then cooled again to 25° C.

Subsequently, 10 g of a stabilizer mixture containing a hindered amine light stabilizer (HALS) and a UV absorber (commercially available under the name GENIOSIL® Stabilizer F from Wacker Chemie AG, D-Munich), 20 g of vinyltrimethoxysilane (commercially available under the name GENIOSIL® XL 10 from Wacker Chemie AG, D-Munich) and 2 g of dioctyltin dilaurate (commercially available under the TIB Kat 216 from TIB Chemicals AG, D-Mannheim) are stirred in for 2 minutes with the cross-arm mixer at 600 rpm and 1000 rpm with the dissolver. There is no appreciable heating of the mixture. Finally, 10 g of N-(2-aminoethyl)-3-aminopropyltrimethoxysilane (commercially available under the name GENIOSIL® GF 9 from Wacker Chemie AG, D-Munich) are stirred in for 2 minutes at 600 rpm with the cross-arm mixer and 1000 rpm with the dissolver. Here, too, there is no appreciable heating of the mixture.

Finally, the mixture is homogenized and stirred bubble-free for 1 minute at 600 rpm with the cross-arm mixer and for 1 minute at 200 rpm with the cross-arm mixer at a pressure of ca. 100 mbar.

The composition thus obtained is filled into 310 ml PE cartridges, sealed airtight and stored for 3 weeks at 23° C. prior to testing.

### EXAMPLE 2

The procedure is as described in Example 1, except that the finished cartridge is stored at 8° C. for 3 weeks prior to testing.

### COMPARATIVE EXAMPLE 1 (C1)

The procedure is as described in Example 1, except that the bubble-free stirred material obtained is used directly in the tests described in Example 3 without any storage.

### COMPARATIVE EXAMPLE 2 (C2)

The procedure is as described in Example 1, except that the finished cartridge is stored at 23° C. for only 24 h prior to the tests described in Example 3.

### COMPARATIVE EXAMPLE 3 (C3)

The procedure is as described in Example 1, except that the finished cartridge is initially stored at 80° C. for 3 h and then at 23° C. for 3 weeks prior to testing.

### COMPARATIVE EXAMPLE 4 (C4)

The procedure is as described in Example 1, except that the finished cartridge is initially stored at 110° C. for 3 h and then at 23° C. for 3 weeks prior to testing.

### COMPARATIVE EXAMPLE 5 (C5)

The procedure is as described in example 1, except that in the first mixing step after the addition of the polyamide (Crayvallac® SLX), the mixture is heated to 80° C. using an external heater and the temperature is maintained for 15 min. All other steps are identical, and also in this case, the finished cartridge is stored for 3 weeks at 23° C.

### EXAMPLE 3: DETERMINATION OF THE PROPERTIES OF THE SAMPLES FROM EXAMPLES 1 AND 2 AND COMPARATIVE EXAMPLES (C1) TO (C4)

Skin Formation Time (SFT)

To determine the skin formation time, the crosslinkable compositions obtained in the examples are applied in a 2 mm thick layer on PE film and stored at standard conditions (23° C. and 50% relative humidity). During curing, the formation of a skin is tested every 5 minutes. For this purpose, a dry laboratory spatula is carefully placed on the surface of the sample and pulled upwards. If the sample sticks to the finger, no skin has yet formed. If no sample remains stuck to the finger, a skin has formed and the time is noted. The results are found in Table 1.

Mechanical Properties

The compositions were each spread on milled-out Teflon panels to a depth of 2 mm and cured for 2 weeks at 23° C., 50% relative humidity.

The Shore A hardness is determined according to DIN EN 53505.

The tensile strength is determined according to DIN EN 53504-S1.

The elongation at break is determined according to DIN EN 53504-S1.

The 100% modulus is determined according to DIN EN 53504-S1.

The results are found in Table 1.

Rheological Properties

The viscosity at 0.1% deformation is determined according to DIN 54458 at 25° C.

The viscosity at 100% deformation is determined according to DIN 54458 at 25° C.

The results are found in Table 1.

TABLE 1

| Composition of example | 1 | 2 | C1 | C2 | C3 | C4 | C5 |
|---|---|---|---|---|---|---|---|
| SFT [min] | 14 | 13 | 14 | 15 | 12 | 12 | 13 |
| Shore A hardness | 45 | 47 | 46 | 45 | 44 | 47 | 46 |
| Tensile strength [N/mm²] | 1.7 | 1.6 | 1.7 | 1.7 | 1.7 | 1.6 | 1.7 |
| Elongation at break [%] | 229 | 238 | 231 | 266 | 245 | 238 | 243 |
| 100% Modulus [MPa] | 1.1 | 1.0 | 1.1 | 1.1 | 1.0 | 1.0 | 1.1 |
| Viscosity at 0.1% deformation [Pas] | 8930 | 5170 | 550 | 650 | 8780 | 7610 | 1860 |
| Viscosity at 100% deformation [Pas] | 93 | 72 | 18 | 20 | 94 | 94 | 38 |

It has been shown that the compositions according to the invention develop thixotropic properties even without thermal treatment during the long storage period according to the invention, which are in no way inferior to the properties of thermally treated compositions and in some cases are even superior.

At the same time, the results of comparative examples C1 and C2 show that when the material according to the invention is filled into a container for final application, for example a cartridge, within 24 hours of production thereof, it has a significantly lower viscosity at the time of filling, both at high and low shear, than at the time of its application, which is carried out only after the storage period according to the invention.

### EXAMPLE 4: PREPARATION OF A LOW-MODULUS SEALANT FORMULATION

100 g of a polypropylene glycol silane-terminated on both sides having an average molar mass (Mₙ) of 18 000 g/mol and end groups of the formula —O—C(═O)—NH—(CH₂)₃—Si(OCH₃)₃ (commercially available under the name GENIOSIL® STP-E35 from Wacker Chemie AG, D-Munich) are homogenized in a laboratory planetary mixer from PC-Laborsystem, equipped with a cross-arm mixer and a dissolver, for 2 minutes with the cross-arm mixer at 200 rpm at ca. 25° C., with 223 g of diisononyl cyclohexane-1,2-dicarboxylate as plasticizer (commercially available under the name “Hexamoll DINCH” from BASF SE; D-Ludwigshafen), 261 g of a calcium carbonate coated with stearic acid having an average particle diameter (D50%) of ca. 2.0 μm (commercially available under the name Omyabond 520 from Omya, D-Cologne), 261 g of an ultrafine calcium carbonate coated with fatty acid having a primary particle size of ca. 30 nm (commercially available under the name Viscoexel® 30 from Shiraishi Omya GmbH, A-Gummern) and 30 g of a micronized polyamide wax having a melting point of 117-127° C. (commercially available under the name Crayvallac® SLX from Arkema, France). The mixture is then stirred for 15 minutes at 600 rpm with the cross-arm mixer and 1000 rpm with the dissolver. The mixture heats up to ca. 41° C. due to the stirring energy introduced. It is then cooled again to 25° C.

Subsequently, 100 g of a one-sided silane-terminated polypropylene glycol having an average molar mass (Mₙ) of 5000 g/mol and end groups of the formula —O—C(═O)—NH—(CH₂)₃—Si(OCH₃)₃ (commercially available under the name GENIOSIL® XM 25 from Wacker Chemie AG, D-Munich), 5 g of a stabilizer mixture containing a hindered amine light stabilizer (HALS) and a UV absorber (commercially available under the name GENIOSIL® Stabilizer F from Wacker Chemie AG, D-Munich), 15 g of vinyltrimethoxysilane (commercially available under the name GENIOSIL® XL 10 from Wacker Chemie AG, D-Munich) and 2 g of a dioctyltin-silane complex (CAS No.: 870 08-6, commercially available under the name TIB Kat 417 from TIB Chemicals AG, D Mannheim) are stirred in for 2 minutes at 600 rpm with the cross-arm mixer and 1000 rpm with the dissolver. There is no appreciable heating of the mixture. Finally, 3 g of N-(2-aminoethyl)-3-aminopropyltrimethoxysilane (commercially available under the name GENIOSIL® GF 9 from Wacker Chemie AG, D-Munich) are stirred in for 2 minutes at 600 rpm with the cross-arm mixer and 1000 rpm with the dissolver. Here, too, there is no appreciable heating of the mixture.

Finally, the mixture is homogenized and stirred bubble-free for 1 minute at 600 rpm with the cross-arm mixer and for 1 minute at 200 rpm with the cross-arm mixer at a pressure of ca. 100 mbar.

The composition thus obtained is filled into 310 ml PE cartridges, sealed airtight and stored for 3 weeks at 23° C. prior to testing.

### COMPARATIVE EXAMPLE 6 (C6)

The procedure is as described in example 3, except that in the first mixing step after the addition of the polyamide (Crayvallac® SLX), the mixture is heated to 80° C. using an external heater and the temperature is maintained for 15 min. All other steps are identical, and also in this case, the finished cartridge is stored for 3 weeks at 23° C.

### EXAMPLE 5: DETERMINATION OF THE PROPERTIES OF THE SAMPLES FROM EXAMPLE 4

Skin formation time, mechanical and rheological properties are determined as described in Example 3. The results are found in Table 2.

TABLE 2

| Composition of example | 4 | C6 |
|---|---|---|
| SFT [min] | 36 | 31 |
| Shore A hardness | 24 | 19 |
| Tensile strength [N/mm²] | 0.9 | 0.9 |
| Elongation at break [%] | 622 | 669 |
| 100% Modulus [MPa] | 0.3 | 0.4 |
| Viscosity at 0.1% deformation [Pas] | 5940 | 5970 |
| Viscosity at 100% deformation [Pas] | 78 | 80 |

It is again shown that the composition according to the invention from example 3 develops thixotropic properties even without thermal treatment during the long storage period according to the invention, which are in no way inferior to the properties of thermally treated composition in comparative example C6.

1-9. (canceled)

10. A method for producing crosslinkable compositions (M) by mixing
(A) 100 parts by weight of compounds of the formula
Y—[(CR¹₂)_{b}—SiRₐ(OR²)₃₋ₐ]ₓ (I),
wherein
Y is an x-valent polymer radical bonded via nitrogen, oxygen, sulfur or carbon,
R may be the same or different and is a monovalent, optionally substituted hydrocarbon radical,
R¹ may be the same or different and is a hydrogen atom or a monovalent, optionally substituted hydrocarbon radical which can be attached to the carbon atom via nitrogen, phosphorus, oxygen, sulfur or a carbonyl group,
R² may be the same or different and is a hydrogen atom or a monovalent, optionally substituted hydrocarbon radical,
x is an integer from 1 to 10,
a may be the same or different and is 0, 1 or 2 and
b may be the same or different and is an integer from 1 to 10, and
(B) 0.1 to 75 parts by weight of at least one thixotropic agent selected from fatty acid amides, polyamide waxes, polyamide wax derivatives, hydrogenated castor oil, hydrogenated castor oil derivatives, polyester amides, polyureas, oxidized polyethylenes and metal soaps and optionally further components,
optionally further subsequent process steps and subsequent storage of the resulting mixture (M),
wherein the period of time from the start of the mixing step of (A) and (B) to the end of storage of the crosslinkable composition (M) is at least 7 days and during this period all process steps are carried out at temperatures below 59° C.

11. The method as claimed in claim 10, wherein all process steps are carried out at temperatures below 49° C.

12. The method as claimed in claim 10, wherein the storage is carried out at a temperature of −20 to 45° C.

13. The method as claimed in claim 10, wherein component (B) is a polyamide wax or polyamide wax derivative.

14. The method as claimed in claim 10, wherein component (B) is a polyamide wax.

15. The method as claimed in claim 10, wherein all process steps are carried out at temperatures which are at least 30° C. below the melting point of the component (B) used, where, if two or more thixotropic agents (B) are used, this specification refers to that thixotropic agent (B) having the highest melting point.

16. The method as claimed in claim 10, wherein
(A) 100 parts by weight of compounds of the formula (I),
(B) 0.1-50 parts by weight of thixotropic agent,
(C) 0.1-25 parts by weight of organosilicon compounds comprising units of the formula
DₑSi(OR⁴)_{d}R³_{c}O_{(4-c-d-e)/2} (II),
where
R³ may be the same or different and is a monovalent, optionally substituted SiC-bonded, nitrogen-free organic radical,
R⁴ may be the same or different and is a hydrogen atom or optionally substituted hydrocarbon radicals,
D may be the same or different and is a monovalent, SiC-bonded radical having at least one nitrogen atom not bonded to a carbonyl group (C═O),
c is 0, 1, 2 or 3,
d is 0, 1, 2 or 3 and
e is 0, 1, 2, 3 or 4,
with the proviso that the sum of c+d+e is less than or equal to 4 and at least one radical D is present per molecule,
optionally (D) non-reactive plasticizers,
optionally (E) fillers,
optionally (F) silicone resins
optionally (G) catalysts,
optionally (H) adhesion promoters,
optionally (I) water scavengers,
optionally (J) additives and
optionally (K) additional materials
are mixed together and then the resulting mixture is stored for at least 7 days, all process steps being carried out at temperatures below 59° C.

17. The method as claimed in claim 10, wherein filling is carried out at a time when the composition (M) at 25° C. has a viscosity measured in accordance with DIN 54458 with a deformation of 100% which is at least a factor of 1.5 below the viscosity measured under identical conditions which the same composition (M) has reached after storage of 21 days at 23° C. after preparation thereof.

18. The method as claimed in claim 10, wherein filling is carried out at a time when the composition (M) at 25° C. has a viscosity measured in accordance with DIN 54458 with a deformation of 0.1% which is at least a factor of 2 below the viscosity measured under identical conditions which the same composition (M) has reached after storage of 21 days at 23° C. after preparation thereof.
